(19) United States
(12) Patent Application Publication
(10) Pub. No.: US 2014/0312125 A1
(43) Pub. Date: Oct. 23, 2014

(54) ONE-DIMENSIONAL BARCODE RESIZING DEVICE, METHOD, NON-TRANSITORY COMPUTER-READABLE MEDIUM, AND ONE-DIMENSIONAL BARCODE SYSTEM

(71) Applicant: FUJIFILM Corporation, Tokyo (JP)

(72) Inventors: Hideyuki NOUMURA, Minato-ku (JP); Toshimitsu FUKUSHIMA, Minato-ku (JP)

(73) Assignee: FUJIFILM CORPORATION, Tokyo (JP)

(21) Appl. No.: 14/252,917

(22) Filed: Apr. 15, 2014

(30) Foreign Application Priority Data
Apr. 17, 2013 (JP) 2013-086800

(51) Int. Cl. G06K 19/06

(52) U.S. Cl. CPC G06K 19/06112
USPC 235/494

(57) ABSTRACT

A one-dimensional barcode resizing device includes a device obtaining information regarding a structure of a one-dimensional barcode, a device obtaining information regarding a resolution of a display device displaying the one-dimensional barcode, and a device determining a scaling factor of the one-dimensional barcode based on the information regarding the structure of the one-dimensional barcode and the information regarding the resolution of the display device, the scaling factor at which a space width of the one-dimensional barcode is equal to an integral multiple of a width of a display pixel of a display device displaying the one-dimensional barcode, the one-dimensional barcode is within a display area of the display device, and a length of the one-dimensional barcode is equal to a read width of a barcode reader required for reading the one-dimensional barcode or more.

### BACKGROUND OF THE INVENTION

1. Field of the Invention

The present invention relates to a one-dimensional barcode resizing device, method, non-transitory computer-readable medium, and one-dimensional barcode system.

2. Description of the Related Art

Japanese Patent Application Laid-Open No. 2002-117372 discloses in paragraph 0053 and FIG. 4 that, when a display of a barcode display device is a monochrome display, the thinnest line in a barcode and a space between lines each have a width of two pixels.

Japanese Patent Application Laid-Open No. 2010-8451 discloses in paragraphs 0032 and 0033 that one-hold display is to display one cell in two-dimensional barcodes of the same contents as one pixel of a liquid-crystal display device, two-fold display is to display one cell in two-dimensional barcodes as two pixels of the liquid-crystal display device, and a user reads a two-dimensional barcode of the most readable size in a reading device carried by user's hand.

Japanese Patent Application Laid-Open No. 2007-025943 discloses in paragraph 0071 that the display device adjusts the size of a graphical code is adjusted according to the size and resolution of the screen.

Japanese Patent Application Laid-Open No. 2003-115025 discloses in paragraph 0019 that the barcode in the barcode image is displayed in a horizontal direction when the screen of a portable telephone is horizontally long and the image of the barcode is displayed in a vertical direction when the screen of the portable telephone is vertically long.

Japanese Patent Application Laid-Open Nos. 11-184959 and 2005-266907 disclose technologies of determining the position and size of a barcode.

### SUMMARY OF THE INVENTION

A service is possible in which a one-dimensional barcode is displayed on a display screen of a portable information terminal such as a portable telephone or smartphone and read by a barcode scanner to provide paperless fee payment. However, when the one-dimensional barcode displayed on the display of the terminal is actually read, even if a barcode image is displayed so as to be within the display, the barcode scanner may not read information properly due to resizing of the barcode.

That is, due to resizing of the one-dimensional barcode on the display screen a white gap (space) between bars in the one-dimensional barcode is narrowed to change its color from white to a halftone such as gray, thereby disadvantageously making it impossible for the barcode reader to accurately recognize the space and accurately read information.

In Japanese Patent Application Laid-Open No. 2002-117372, the thinnest line in a barcode and a space between lines each have a width of two pixels. However, it is not known whether this barcode is within a display area of the display and, even if so, whether the barcode complies with standards which allow the barcode reader to accurately read information.

The present invention provides a technique for displaying a one-dimensional barcode so that a barcode reader can read information from a display screen.

The present invention provides a one-dimensional barcode resizing device including a device obtaining information regarding a structure of a one-dimensional barcode, a device obtaining information regarding a resolution of a display device displaying the one-dimensional barcode, and a device determining a scaling factor of the one-dimensional barcode based on the information regarding the structure of the one-dimensional barcode and the information regarding the resolution of the display device, the scaling factor at which a space width of the one-dimensional barcode is equal to an integral multiple of a width of a display pixel of a display device displaying the one-dimensional barcode, the one-dimensional barcode is within a display area of the display device, and a length of the one-dimensional barcode is equal to a read width of a barcode reader required for reading the one-dimensional barcode or more.

Preferably, the information regarding the structure of the one-dimensional barcode includes the length, a bar width, and the space width of the one-dimensional barcode.

Preferably, the device obtaining the information regarding the structure of the one-dimensional barcode obtains the information regarding the structure of the one-dimensional barcode by analyzing image information of the one-dimensional barcode.

Preferably, the length of the one-dimensional barcode is defined by coordinates of a start point and an end point of the one-dimensional barcode.

Preferably, the information regarding the resolution of the display device includes a length of the display device and a number of pixels per unit length of the display device.

Preferably, the one-dimensional barcode resizing device further includes a device enlarging or reducing the one-dimensional barcode at the determined scaling factor.

Preferably, the one-dimensional barcode resizing device further includes a device assessing whether a halftone occurs in a space of the enlarged or reduced one-dimensional barcode and a device, when it is assessed that a halftone occurs in the space of the enlarged or reduced one-dimensional barcode, repeatedly changing the determined scaling factor until it is assessed the halftone does not occur.

Preferably, the one-dimensional barcode resizing device further includes a device displaying the enlarged or reduced one-dimensional barcode on the display device.

The present invention provides a one-dimensional barcode resizing method for a computer to perform steps including obtaining information regarding a structure of a one-dimensional barcode, obtaining information regarding a resolution of a display device displaying the one-dimensional barcode, and determining a scaling factor of the one-dimensional barcode based on the information regarding the structure of the one-dimensional barcode and the information regarding the resolution of the display device, the scaling factor at which a space width of the one-dimensional barcode is equal to an integral multiple of a width of a display pixel of a display device displaying the one-dimensional barcode, the one-dimensional barcode is within a display area of the display device, and a length of the one-dimensional barcode is equal to a read width of a barcode reader required for reading the one-dimensional barcode or more.

Also, the present invention provides a non-transitory computer-readable medium having stored thereon a one-dimensional barcode resizing program for causing a computer to function as the above-described one-dimensional barcode resizing device.

Furthermore, the present invention provides a one-dimensional barcode system including the above-described one-dimensional barcode resizing device and a barcode reader reading a one-dimensional barcode displayed on the display device.

The one-dimensional barcode resized by the present invention has a space width equal to an integral multiple of the width of the display pixel, is within the display area for the one-dimensional barcode information, and has a length equal to the read width of the barcode reader required for reading the one-dimensional barcode information or more. Therefore, a halftone does not occur in a space between narrow bars or between wide bars, and the displayed one-dimensional barcode can be accurately read by the barcode reader.

### BRIEF DESCRIPTION OF THE DRAWINGS

FIG. 1 is a diagram depicting the structure of an information display device according to a first embodiment;

FIGS. 2A and 2B are diagrams depicting an example of a one-dimensional barcode and a narrow space width of the one-dimensional barcode;

FIGS. 3A to 3E are diagrams each depicting an example of a space width of the one-dimensional barcode;

FIGS. 4A and 4B are diagrams depicting an example of assessment results regarding candidates of a scaling factor and assessment results regarding a final resizing ratio for each of a one-dimensional barcode BC1 and a one-dimensional barcode BC2 on different terminals A and B;

FIGS. 5A and 5B are diagrams each exemplarily depicting part of the one-dimensional barcode and its display pixels before and after resizing;

FIG. 6 is a flowchart of a barcode display process according to the first embodiment;

FIG. 7 is a diagram depicting the structure of an information display device according to a second embodiment;

FIG. 8A is a diagram depicting an example of a barcode image BC1;

FIG. 8B is a diagram depicting an example of a barcode image BC2;

FIGS. 9A and 9B are diagrams each depicting an example of a start position and an end position of the one-dimensional barcode;

FIGS. 10A and 10B are diagrams each depicting a size of the one-dimensional barcode;

FIG. 11 is a flowchart of a barcode display process according to the second embodiment;

FIG. 12 is a diagram depicting the structure of an information display device according to a third embodiment;

FIGS. 13A to 13C are diagram each depicting an example of an initial resizing ratio; and

FIG. 14 is a flowchart of a barcode display process according to a third embodiment.

### DETAILED DESCRIPTION OF THE PREFERRED EMBODIMENTS

### First Embodiment

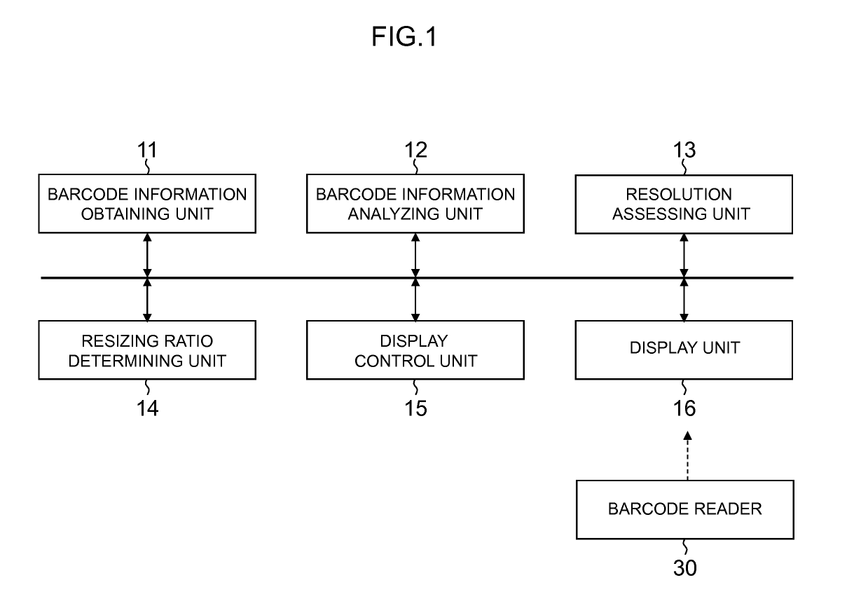

FIG. 1 is a diagram depicting the structure of an information display device 1 according to a first preferred embodiment of the present invention. The information display device 1 is configured of an information processing device including, for example, a computing device (CPU), a storage device, an input/output circuit, a communication circuit, a user interface, and a display device. The information processing device may be a non-portable device such as a desktop personal computer or smart television, but the preset invention is mainly applied to a portable device with a small display size, such as a smartphone, portable information terminal, or tablet personal computer.

The information display device 1 includes a barcode information obtaining unit 11, a barcode information analyzing unit 12, a resolution assessing unit 13, a resizing ratio determining unit 14, a display control unit 15, and a display unit 16. Part or all of the blocks other than the display control unit 15 and the display unit 16 are included in an information processing device other than the information display device 1. Upon a notification of the resizing ratio determined by the resizing ratio determining unit of the other information processing device, the display control unit 15 and the display unit 16 cause the one-dimensional barcode to be magnified or reduced and displayed according to this resizing ratio. A barcode system of the present invention includes the information display device 1 and a barcode reader 30 which reads the one-dimensional barcode displayed on the display unit 16 of the information display device 1.

The barcode information obtaining unit 11 obtains one-dimensional barcode information. The one-dimensional barcode information includes one-dimensional barcode image information itself and information (text and a numerical value) required for generating output data (such as an image file and print data) of the image information.

The barcode information analyzing unit 12 analyzes the structure of the one-dimensional barcode from the one-dimensional barcode information obtained by the barcode information obtaining unit 11. The structure of the one-dimensional barcode includes a quiet zone (margin), a start/stop character, data (message), check digit, the length of the barcode (a length including left and right quiet zones), the height of the barcode, narrow bar width, wide bar width, narrow space width, wide space width, etc. In addition, the one-dimensional barcode information includes information required for specifying barcode standards, such as a country number and manufacturer code of the barcode.

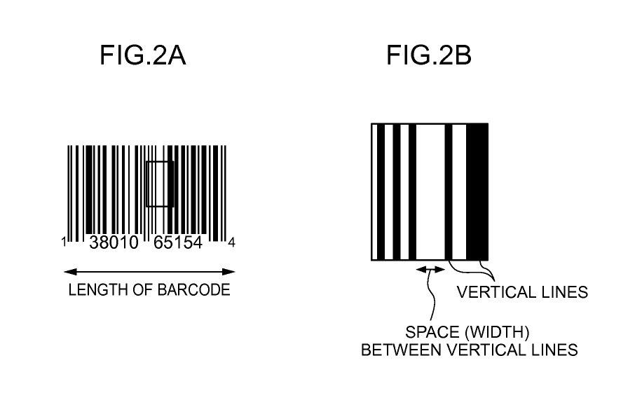

FIG. 2A depicts an example of the one-dimensional barcode information, and FIG. 2B depicts an example of the narrow space width and the wide space width of the one-dimensional barcode information.

A ratio between the narrow bar width and the wide bar width is equal to a ratio between the narrow space width and the wide space width, and is normally defined by 1:2 to 1:3. In the present embodiment, the ratio between the narrow space width and the wide space width of the one-dimensional barcode information is assumed to be always an integer ratio. That is, it is assumed that the wide space width can be represented by an integral multiple of the narrow space width.

The resolution assessing unit 13 obtains information regarding the resolution of the display unit 16 for displaying the one-dimensional barcode. The information regarding the resolution includes dimensions (inches) of the length and width (or diagonal line) of the display unit 16, the image resolution (pixels) of the display unit 16, the pixel density (for example, the number of pixels (DPI) per inch (=2.54 mm) of the display unit 16), and the aspect ratio of the display unit 16. The information regarding the resolution can be obtained from a memory incorporated in the information display device 1 or an external information device connected via a network or the like. The resolution assessing unit 13 may obtain dimensions of the length and width of the display unit 16 and its screen resolution and calculate a pixel density from the obtained information.

When the information regarding the resolution is obtained from an external server, the information display device 1 may notify the server of a terminal type and an ID, and the server may transmit, to the information display device 1, the information regarding the resolution corresponding to the terminal type and the ID obtained by the notification. For example, when the information display device 1 is a smartphone X of an A company, the server transmits a screen size=3.5 inches, a resolution=320×480 pixels, and a pixel density=163 dpi, etc., to the information display device 1 as information regarding the resolution corresponding to the smartphone X of the A company, and the resolution assessing unit 13 stores the received information in the memory as the information regarding the resolution.

When the one-dimensional barcode is displayed not to full screen on the display unit 16 but in a display area of an application, the resolution assessing unit 13 finds information regarding the resolution of the display area from the information regarding the resolution of the display unit 16 itself and the size of the length and width of the display area, and stores the found information in the memory as the information regarding the resolution corresponding to the display area of the application.

The resizing ratio determining unit 14 determines a resizing ratio of the one-dimensional barcode information obtained by the barcode information obtaining unit 11 based on the information regarding the resolution stored in the resolution assessing unit 13 and the structure of the one-dimensional barcode analyzed by the barcode information analyzing unit 12.

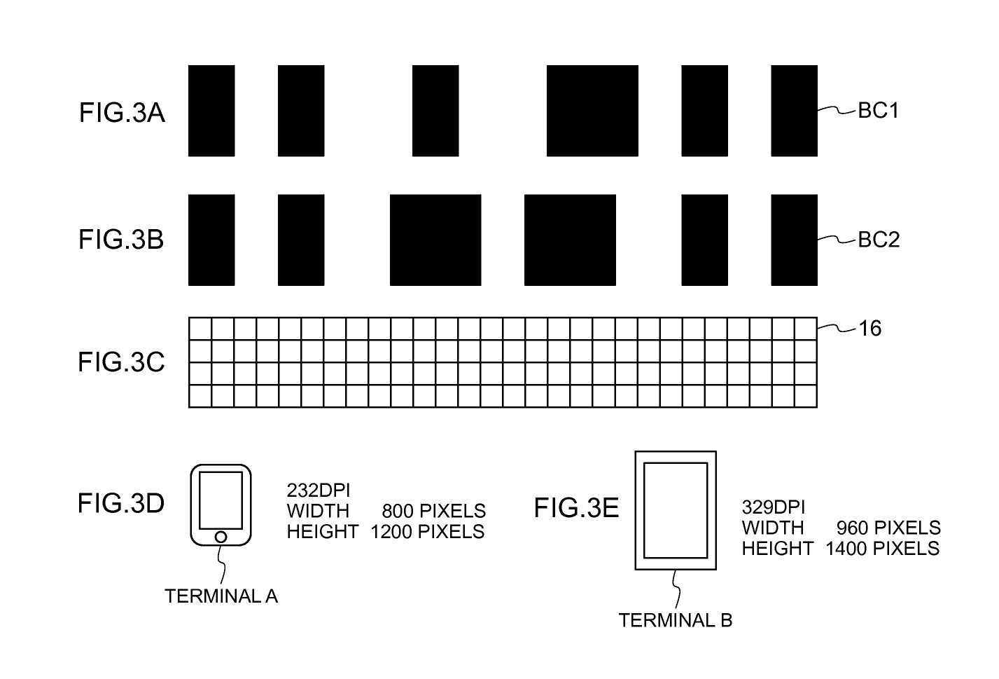

That is, the resizing ratio determining unit 14 determines a scaling factor at which (1) a space width (including the narrow space width and the wide space width) of the one-dimensional barcode is equal to an integral multiple of a pixel (a picture element of a minimum unit) of the display unit 16 (refer to FIGS. 3A to 3E), (2) the quiet zone is within the display area of the one-dimensional barcode information in the display unit 16, and (3) the length of the barcode is equal to a read width of the barcode reader 30 required for reading the one-dimensional barcode information or more. The resizing ratio determining unit 14 assesses scaling factors satisfying any of the conditions (1) to (3) described above, takes these scaling factors as resizing ratio determination candidates, selects a scaling factor satisfying all of the conditions (1) to (3) from the resizing ratio determination candidates, and determines the selected scaling factor as a final resizing ratio.

When a plurality of scaling factor candidates satisfying all of the conditions (1) to (3) are present, the resizing ratio determining unit 14 determines a maximum value among these candidates as a scaling factor. However, a plurality of scaling factor candidates satisfying all of the conditions (1) to (3) are present, the user may select any scaling factor and determine the selected scaling factor as a resizing ratio.

For example, as depicted in FIG. 3A, it is assumed that the narrow space width of a one-dimensional barcode BC1=two (pixels), the length of the barcode=300 (mm), and the height of the barcode=100 (mm) Also, as depicted in FIG. 3D, it is assumed that, regarding the display area of the display unit 16 in a terminal A, which is one type of the information display device 1, the width of the display area=800 (pixels), the height of the display area=1200 (pixels), and the pixel density of the display unit 16=232 (DPI).

The narrow space width allows an integral (1, 2, 3, . . . ) multiple of one pixel.

### Therefore,

when the scaling factor=0.5, the narrow space width=2×0.5=one pixel;

when the scaling factor=1, the narrow space width=2×1=two pixels;

when the scaling factor=2, the narrow space width=2×2=four pixels; and

when the scaling factor=3, the narrow space width=2×3=six pixels.

Also, since 1 inch=25 4 mm, the width of the display unit 16 for one pixel is 25.4 (mm)/232 (dpi)=0.1090.11 (mm)

Then,

when the scaling factor=0.5, the narrow space width=0. 11 mm and barcode width after scaling=150 pixels=16 mm;

when the scaling factor=1, the narrow space width=0. 22 mm and barcode width after scaling=300 pixels=33 mm;

when the scaling factor=2, the narrow space width=0. 44 mm and barcode width after scaling=600 pixels=66 mm; and

when the scaling factor=3, the narrow space width=0.66 mm and barcode width after scaling=900 pixels=99 mm.

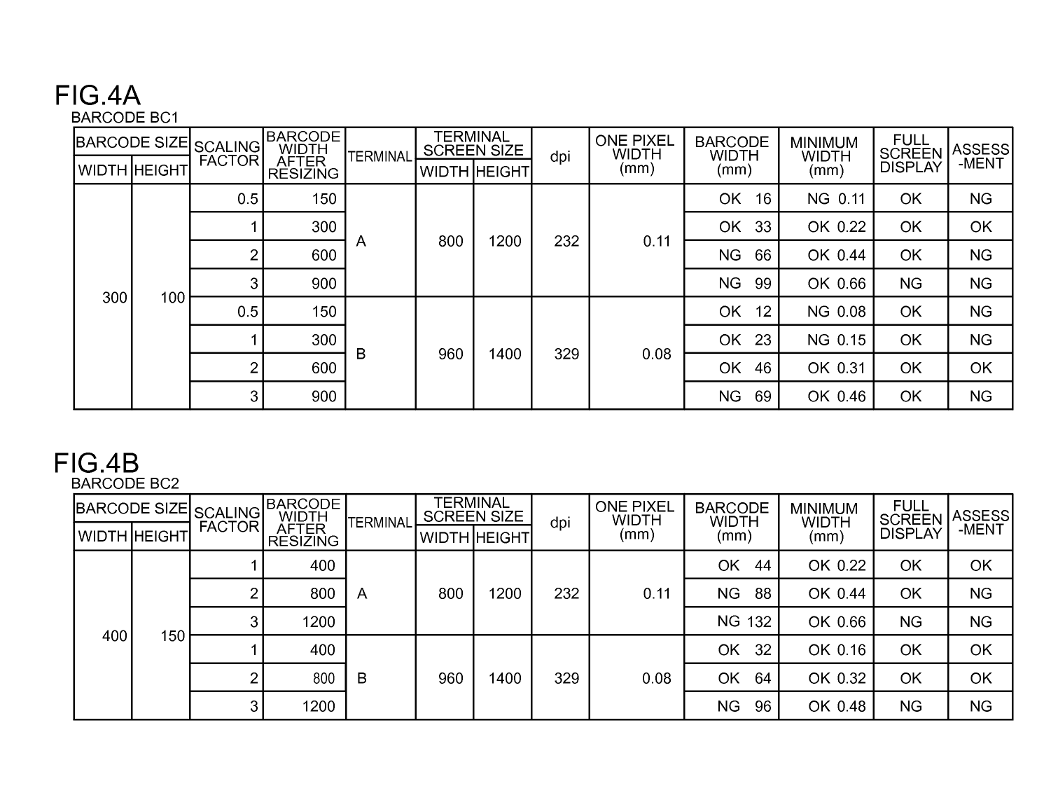

As standards for the one-dimensional barcode BC1, it is assumed that the narrow space width is defined as 0.2 mm or more and the barcode width is defined as 60 mm or less. In this case, the narrow space width=0.11 mm corresponding to the scaling factor=0.5 does not satisfy the standards. Also, the barcode width=66 mm and 99 mm after magnification corresponding to the scaling factor=2 and 3 do not satisfy the standards. Furthermore, the barcode width after magnification corresponding to the scaling factor=3 exceeds the width of the display area of 800 pixels. Therefore, as depicted in FIG. 4A, the scaling factor=0.5, 2, and 3 are excluded from the resizing ratio determination candidates.

As such, it is assessed that the one-dimensional barcode BC1 can be displayed in the display area of the display unit 16 so as to satisfy the standards only when the scaling factor=1. The resizing ratio determining unit 14 determines the scaling factor=1 as a resizing ratio of the one-dimensional barcode BC1 on the terminal A.

Alternatively, as exemplarily depicted in FIG. 3E, regarding a terminal B, which is the information display device 1 of another type, it is assumed hat the width of the display area of the display unit 16=960 (pixels), the height of the display area=1400 (pixels), and the pixel density of the display unit 16=329 (DPI). In this case, as exemplarily depicted in FIG. 4A, a barcode can be displayed so as to satisfy all of the conditions (1) to (3) when the scaling factor=2. The resizing ratio determining unit 14 determines the scaling factor=2 as a resizing ratio of the one-dimensional barcode BC1 on the terminal B.

Still alternatively, as depicted in FIG. 3B, it is assumed that the narrow space width of the one-dimensional barcode BC2=2 (pixels), the length of the barcode=400 (mm), and the height of the barcode=150 (mm) Furthermore, as standards for the one-dimensional barcode BC2, it is assumed that the minimum width of the narrow space width is defined as 0.1 mm or more and the barcode width is defined as 80 mm or less. In this case, as exemplarily depicted in FIG. 4B, the one-dimensional barcode BC2 satisfying the standards can be displayed when the scaling factor=1 for the terminal A and when the scaling factor=1 or 2 on the terminal B. The resizing ratio determining unit 14 determines the scaling factor 1 for the terminal A and the scaling factor=2 for the terminal B as a resizing ratio of the one-dimensional barcode BC2.

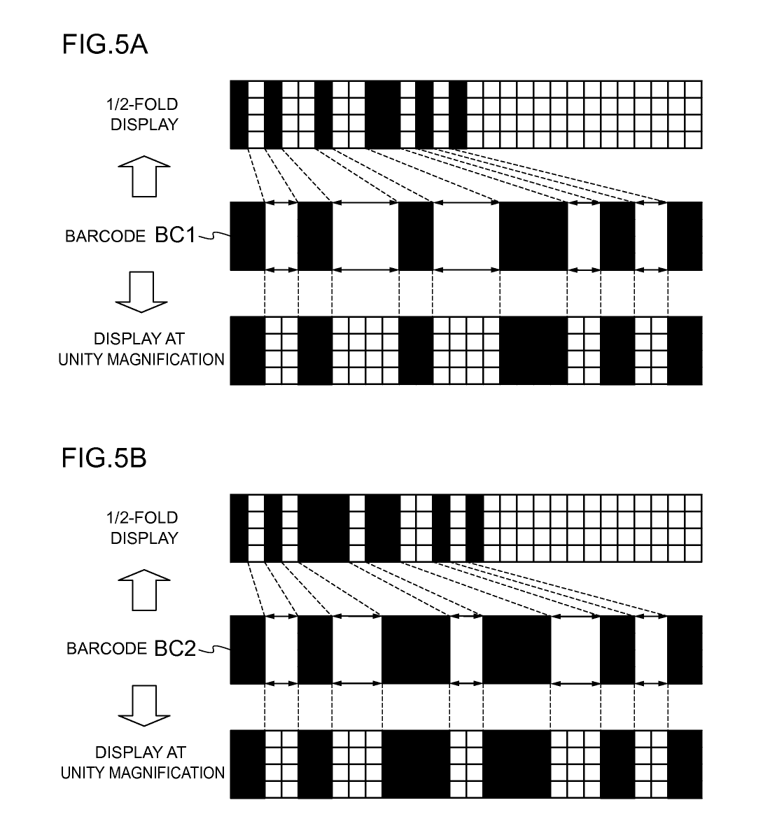

FIG. 5A depicts part of the one-dimensional barcode BC1, and display pixels of the part of the one-dimensional barcode BC1 at unity magnification and those after resizing at the scaling factor=0.5 displayed on the display unit 16, and FIG. 5B depicts part of the one-dimensional barcode BC2, and display pixels of the part of the one-dimensional barcode BC2 at unity magnification and those after resizing at the scaling factor=0.5 displayed on the display unit 16.

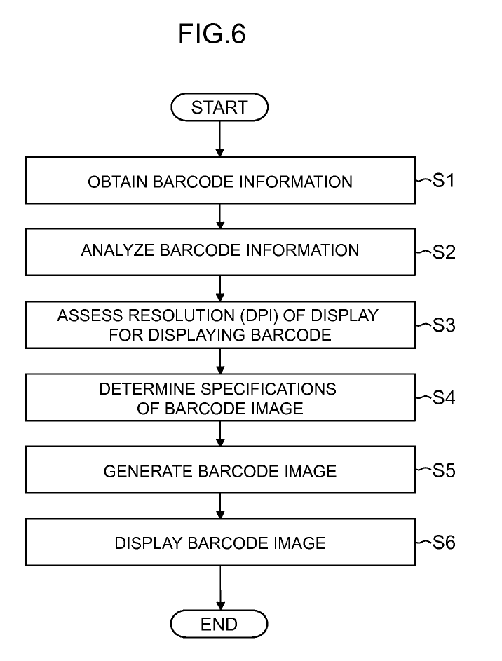

FIG. 6 is a flowchart of a barcode display process according to the first embodiment. A program causing the information processing device such as the information display device 1 to perform this process is recorded in a computer-readable recording medium of the information processing device.

At S1, the barcode information obtaining unit 11 obtains one-dimensional barcode information.

At S2, the barcode information analyzing unit 12 obtains the standards for the one-dimensional barcode from the one-dimensional barcode information obtained by the barcode information obtaining unit 11 and analyzes the structure of the one-dimensional barcode.

At S3, the resolution assessing unit 13 obtains information regarding the resolution of the display unit 16 and the display area. From this information, the resolution assessing unit 13 calculates a pixel density of the display unit 16.

At S4, the resizing ratio determining unit 14 determines a resizing ratio for the one-dimensional barcode, the resizing ratio satisfying all of the above-described condition (1) to (3), based on the information regarding the resolution obtained by the resolution assessing unit 13, the structure of the one-dimensional barcode analyzed by the barcode information analyzing unit 12 and the standards for the one-dimensional barcode.

At S5, the display control unit 15 resizes the one-dimensional barcode at the resizing ratio determined by the resizing ratio determining unit 14.

At S6, the display control unit 15 causes the resized one-dimensional barcode to be displayed on the display unit 16. If the display area is not provided, the resized one-dimensional barcode is displayed to full screen on the display unit 16. If the display area is provided, the resized one-dimensional barcode is displayed in the display area.

The one-dimensional barcode displayed on the display unit 16 in the manner described above is such that (1) the space width of the one-dimensional barcode is equal to an integral multiple of a pixel (a picture element of a minimum unit) of the display unit 16 (refer to FIGS. 3A to 3E), (2) the quiet zone is within the display area of the one-dimensional barcode information in the display unit 16, and (3) the length of the barcode is equal to a read width of the barcode reader 30 required for reading the one-dimensional barcode information or more. Therefore, a halftone does not occur in a space between narrow bars or between wide bars, and the one-dimensional barcode displayed on the display unit 16 can be accurately read by the barcode reader 30.

### Second Embodiment

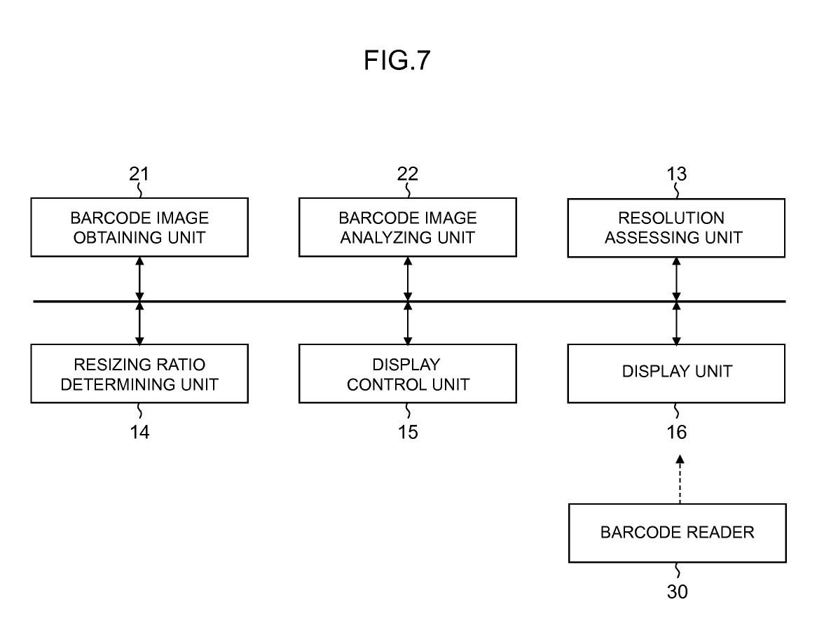

FIG. 7 depicts the structure of the information display device 1 according to a second preferred embodiment of the present invention.

The information display device 1 includes a barcode image obtaining unit 21, a barcode image analyzing unit 22, the resolution assessing unit 13, the resizing ratio determining unit 14, the display control unit 15, and the display unit 16. A block with a function similar to that of the first embodiment is provided with the same reference numeral.

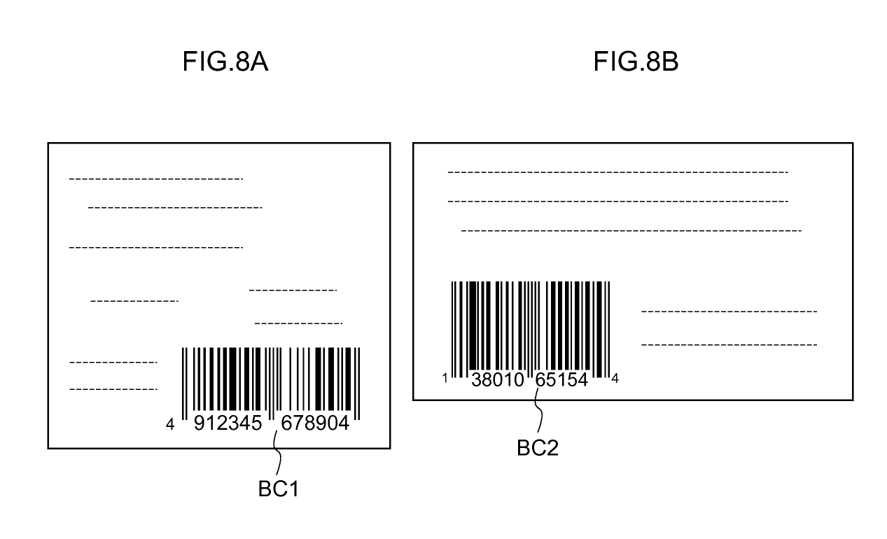

The barcode image obtaining unit 21 obtains an image including a one-dimensional barcode. The one-dimensional barcode image may be image data obtained by imaging a one-dimensional barcode presented on part of a print file such as a PDF or a printed matter such as an invoice by an imaging device. FIGS. 8A and 8B depict examples of one-dimensional barcode images BC1 and BC2, respectively. Information required for specifying the standards for the barcode is assumed to be stored in advance in the information display device 1 or captured into the information display device 1 via appropriate means such as a network.

The barcode image analyzing unit 22 analyzes the structure of the one-dimensional barcode from the one-dimensional barcode image obtained by the barcode image obtaining unit 21. The structure of the one-dimensional barcode includes a quiet zone (margin), a start/stop character, data (message), check digit, the length of the barcode (a length including left and right quiet zones), the height of the barcode, narrow bar width, wide bar width, narrow space width, wide space width, etc. Analysis of the structure of the one-dimensional barcode from the image information can be performed by using conventional techniques as disclosed in Japanese Patent Application Laid-Open No. 2005-266907.

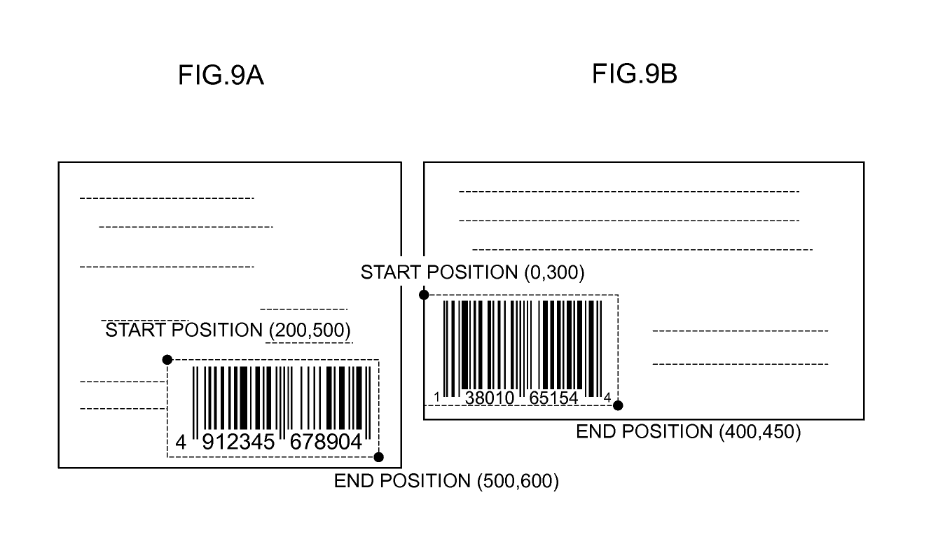

The barcode image analyzing unit 22 analyzes coordinates of the one-dimensional barcode in the image in order to specify the position of the one-dimensional barcode in the image. For example, as depicted in FIG. 9A, the barcode start position of the one-dimensional barcode BC1 is (200, 500), and its end position is (500, 600). Alternatively, as depicted in FIG. 9B, the barcode start position of the one-dimensional barcode BC2 is (0, 300) and its end position is (400, 450).

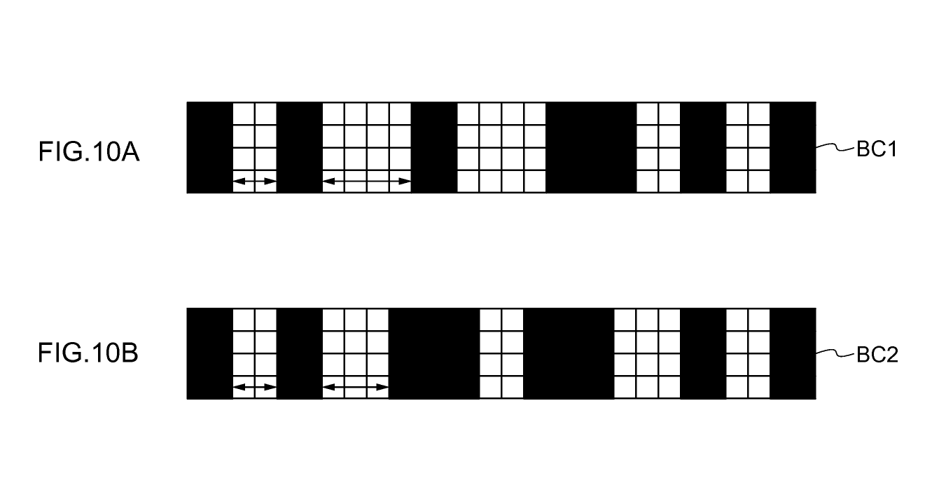

The barcode image analyzing unit 22 analyzes the size from the coordinates of the one-dimensional barcode. As with the first embodiment, the size of the one-dimensional barcode is represented by pixels, For example, as exemplarily depicted in FIG. 10A, the barcode narrow bar width of the barcode BC1=300 pixels, the height of the barcode=100 pixels, the narrow space width=two pixels, and the wide space width=four pixels. Alternatively, as exemplarily depicted in FIG. 10B, the narrow bar width of the barcode BC2=300 pixels, the height of the barcode=100 pixels, the narrow space width=two pixels, and the wide space width=three pixels.

The resolution assessing unit 13 obtains information regarding the resolution of the display unit 16 for displaying the one-dimensional barcode. This function is similar to that of the first embodiment. The resolution assessing unit 13 may obtain information corresponding to the type of its own terminal type form among those stored in a database of a server other than the information display device 1 in association with a plurality of types of terminals and may take the obtained information as information regarding the resolution of the display unit 16. When the information display device 1 has an API (Application Programming Interface) for obtaining the information from a database of the server, this API may be used to obtain information in association with its own terminal type from the server.

The resizing ratio determining unit 14 determines a scaling factor at which (1) the space width (including the narrow space width and the wide space width) of the one-dimensional barcode is equal to an integral multiple of a pixel (a picture element of a minimum unit) of the display unit 16, (2) the quiet zone is within the display area of the one-dimensional barcode information in the display unit 16, and (3) the length of the barcode is equal to a read width of the barcode reader 30 required for reading the one-dimensional barcode information or more. This is the same as that of the first embodiment. The resizing ratio determining unit 14 determines a maximum value of scaling factors satisfying any of the conditions (1) to (3) described above as a resizing ratio.

The display control unit 15 resizes the one-dimensional barcode at the scaling factor determined by the resize ratio determining unit 14, and causes the resized one-dimensional barcode to be displayed on the display unit 16.

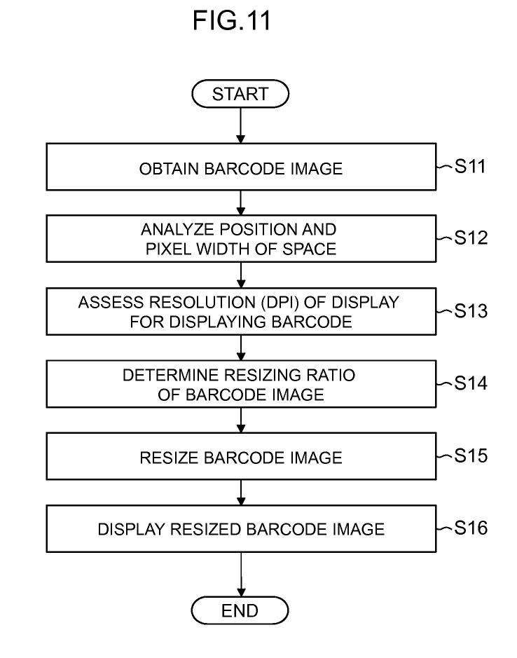

FIG. 11 is a flowchart of a barcode display process according to the second embodiment. A program causing the information processing device such as the information display device 1 to perform this process is recorded in a non-transitory computer-readable recording medium of the information processing device such as RAM, ROM, CD-ROM, DVD, and HDD.

At S11, the barcode image obtaining unit 21 obtains an image including the one-dimensional barcode.

At S12, the barcode image analyzing unit 22 specifies coordinates of the one-dimensional barcode from the image obtained by the barcode image obtaining unit 21 and analyzes the structure of the one-dimensional barcode (such as the space width). The barcode image analyzing unit 22 also obtains the standards for the one-dimensional barcode from a server or the like or the standards for the one-dimensional barcode stored in advance in a memory or the like.

At S13, the resolution assessing unit 13 obtains information regarding the resolution of the display unit 16 and the display area.

At S14, the resizing ratio determining unit 14 determines a resizing ratio for the one-dimensional barcode, the resizing ratio satisfying all of the above-described condition (1) to (3), based on the information regarding the resolution obtained by the resolution assessing unit 13, the structure of the one-dimensional barcode analyzed by the barcode information analyzing unit 22, and the standards for the one-dimensional barcode.

At S15, the display control unit 15 resizes the original ne-dimensional barcode image at the resizing ratio determined by the resizing ratio determining unit 14 to generate an image of the one-dimensional barcode after resizing.

At S16, the display control unit 15 causes the resized one-dimensional barcode to be displayed in the display area of the display unit 16. If the display area is the entire display unit 16, the resized one-dimensional barcode is displayed to full screen on the display unit 16. If a display area is provided, the resized one-dimensional barcode is displayed in the display area.

The one-dimensional barcode displayed on the display unit 16 in the manner described above is such that (1) the space width of the one-dimensional barcode is equal to an integral multiple of a pixel (a picture element of a minimum unit) of the display unit 16, (2) the quiet zone is within the display area of the one-dimensional barcode information in the display unit 16, and (3) the length of the barcode is equal to a read width of the barcode reader 30 or more. Therefore, a halftone does not occur in a space between narrow bars or between wide bars, and the one-dimensional barcode displayed on the display unit 16 can be accurately read by the barcode reader 30.

### Third Embodiment

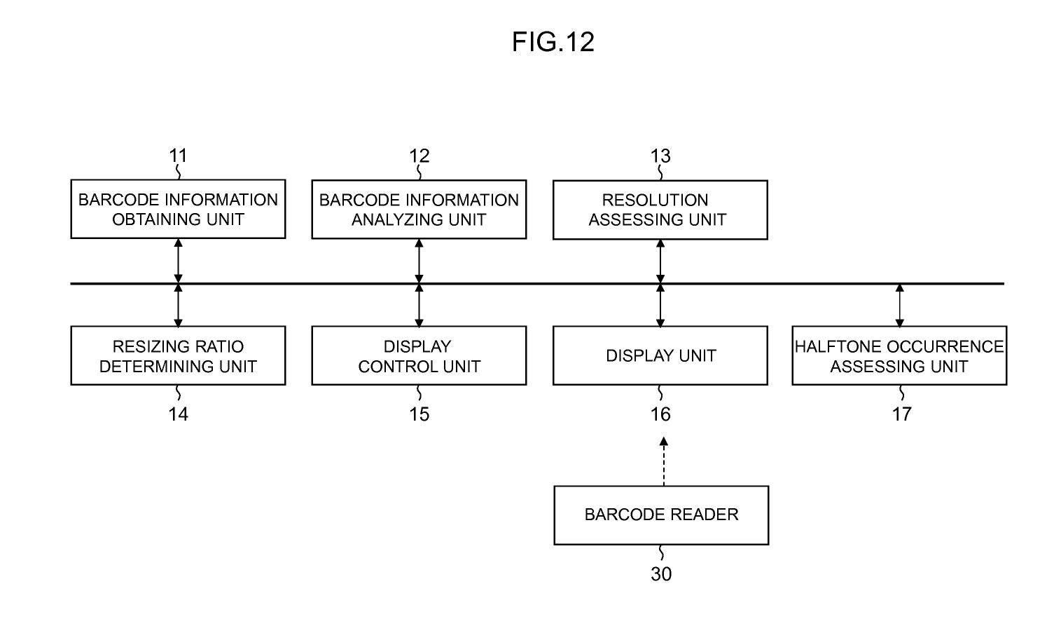

FIG. 12 depicts the structure of the information display device 1 according to a third embodiment.

The information display device 1 includes the barcode information obtaining unit 11, the barcode information analyzing unit 12, the resolution assessing unit 13, the resizing ratio determining unit 14, the display control unit 15, the display unit 16, and a halftone occurrence assessing unit 17. A block with a function similar to that of the first embodiment is provided with the same reference numeral.

The resizing ratio determining unit 14 determines an initial resizing ratio of the one-dimensional barcode. For example, the initial resizing ratio is an upper-limit value in a range where the length of the one-dimensional barcode can be displayed in the display area of the display unit 16. In other words, the initial resizing ratio is such that the length of the barcode matches the width of the display unit 16.

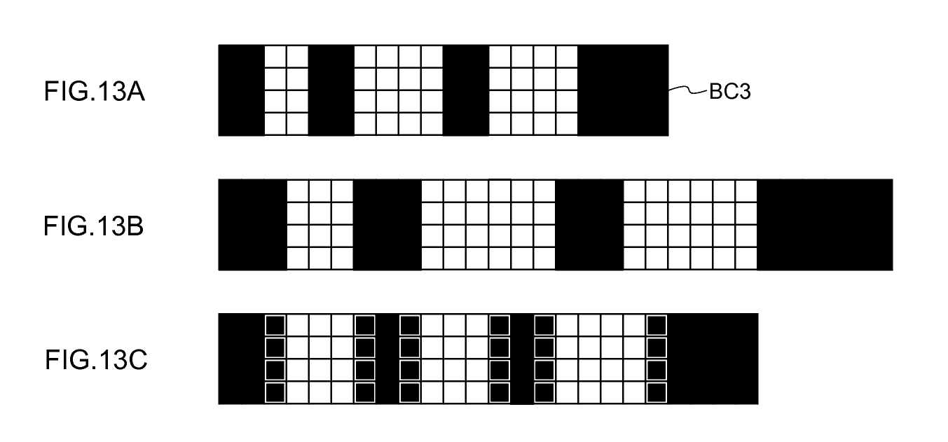

By way of example, regarding a barcode BC3 with a barcode length of 200 pixels as depicted in FIG. 13A, the initial resizing ratio for the display area with a width=300 (pixels) is 1.5, as depicted in FIG. 13B. The initial resizing ratio for the display area with a width=240 (pixels) is 1.2, as depicted in FIG. 13C.

The display control unit 15 resizes the one-dimensional barcode at the initial resizing ratio. The halftone occurrence assessing unit 17 assesses whether a halftone (a color other than white and black) occurs in pixels configuring the image information of the one-dimensional barcode resized at the initial resizing ratio. For example, the halftone occurrence assessing unit 17 scans the image information of the one-dimensional barcode after resizing and searches for a pixel matching the value of a halftone (a value other than 0 and 255).

When the halftone occurrence assessing unit 17 assesses that a halftone occurs in a display pixel, the resizing ratio determining unit 14 changes the initial resizing ratio of the one-dimensional barcode. For example, the display control unit 15 adds a predetermined increment value (such as 0.1) or decrement value (such as −0.1) to the initial resizing ratio of the one-dimensional barcode BC3. By way of example, the resizing ratio is changed from 1.2 times to 1.1 times (decrement value=−0.1) or 1.0 times (decrement value=−0.2).

Alternatively, the display control unit 15 changes the resizing ratio by cutting off the fractional portion of the current resizing ratio of the one-dimensional barcode. That is, when the current resizing ratio of the one-dimensional barcode=2.5, the changed resizing ratio=[2.5]=2. When the current resizing ratio of the one-dimensional barcode=3.1, the changed resized ratio=[3.1]=3 ([] represents a Gauss symbol).

The display control unit 15 resizes the one-dimensional barcode at the changed resizing ratio. The halftone occurrence assessing unit 17 assesses that a halftone occurs in a pixel for the one-dimensional barcode after the resizing ratio is changed. When it is assessed that a halftone occurs, the display control unit 15 again changes the current resizing ratio of the one-dimensional barcode. When it is assessed that a halftone does not occur, the display control unit 15 does not change the resizing ratio. In short, when it is assessed that a halftone occurs in the one-dimensional barcode resized at the initial resizing ratio, the resizing ratio of the one-dimensional barcode is repeatedly changed until it is assessed that a halftone does not occur.

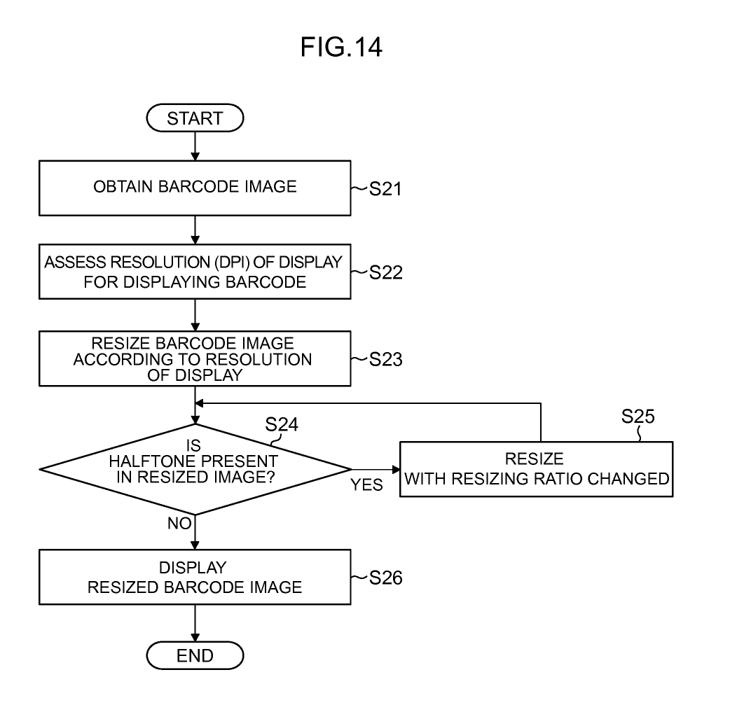

FIG. 14 is a flowchart of a barcode display process according to the third embodiment. A program causing the information processing device such as the information display device 1 to perform this process is recorded in a computer-readable recording medium of the information processing device.

At S21, the barcode information obtaining unit 11 obtains barcode information. This information may be image information itself or information required for generating image information.

At S22, the resolution assessing unit 13 obtains information regarding the resolution of the display unit 16 for displaying the one-dimensional barcode (pixel density).

At S23, the resizing ratio determining unit 14 determines an initial resizing ratio for the one-dimensional barcode, the resizing ratio satisfying all of the above-described condition (1) to (3), based on the information regarding the resolution obtained by the resolution assessing unit 13, the structure of the one-dimensional barcode analyzed by the barcode information analyzing unit 12, and the standards for the one-dimensional barcode. The display control unit 15 resizes the one-dimensional barcode at the resizing ratio determined by the resizing ratio determining unit 14.

At S24, the halftone occurrence assessing unit 17 assesses whether a halftone occurs in a display pixel of the resized one-dimensional barcode. When it is assessed that a halftone occurs, the procedure proceeds to S25. When it is assessed that a halftone does not occur, the procedure proceeds to S26.

At S25, the display control unit 15 changes the resizing ratio of the one-dimensional barcode, and resizes the one-dimensional barcode at the changed resizing ratio. The procedure then returns to S24.

At S26, the display control unit 15 causes the resized one-dimensional barcode to be displayed on the display unit 16.

As such, assessment as to whether a halftone occurs and change of the resizing ratio are repeatedly performed to determine a resizing ratio at which a halftone does not occur, and the one-dimensional barcode is displayed at this resizing ratio. With this, the one-dimensional barcode can be accurately read.

What is claimed is:

1. A one-dimensional barcode resizing device, comprising:
a device obtaining information regarding a structure of a one-dimensional barcode;
a device obtaining information regarding a resolution of a display device displaying the one-dimensional barcode; and
a device determining a scaling factor of the one-dimensional barcode based on the information regarding the structure of the one-dimensional barcode and the information regarding the resolution of the display device, the scaling factor at which a space width of the one-dimensional barcode is equal to an integral multiple of a width of a display pixel of a display device displaying the one-dimensional barcode, the one-dimensional barcode is within a display area of the display device, and a length of the one-dimensional barcode is equal to a read width of a barcode reader required for reading the one-dimensional barcode or more.

2. The one-dimensional barcode resizing device according to claim 1, wherein
the information regarding the structure of the one-dimensional barcode includes the length, a bar width, and the space width of the one-dimensional barcode.

3. The one-dimensional barcode resizing device according to claim 2, wherein
the device obtaining the information regarding the structure of the one-dimensional barcode obtains the information regarding the structure of the one-dimensional barcode by analyzing image information of the one-dimensional barcode.

4. The one-dimensional barcode resizing device according to claim 3, wherein
the length of the one-dimensional barcode is defined by coordinates of a start point and an end point of the one-dimensional barcode.

5. The one-dimensional barcode resizing device according to claim 1, wherein
the information regarding the resolution of the display device includes a length of the display device and a number of pixels per unit length of the display device.

6. The one-dimensional barcode resizing device according to claim 1, further comprising a device enlarging or reducing the one-dimensional barcode at the determined scaling factor.

7. The one-dimensional barcode resizing device according to claim 6, further comprising:
a device assessing whether a halftone occurs in a space of the enlarged or reduced one-dimensional barcode; and
a device, when it is assessed that a halftone occurs in the space of the enlarged or reduced one-dimensional barcode, repeatedly changing the determined scaling factor until it is assessed the halftone does not occur.

8. The one-dimensional barcode resizing device according to claim 7, further comprising a device displaying the enlarged or reduced one-dimensional barcode on the display device.

9. A one-dimensional barcode resizing method for a computer to perform steps comprising:
obtaining information regarding a structure of a one-dimensional barcode;
obtaining information regarding a resolution of a display device displaying the one-dimensional barcode; and
determining a scaling factor of the one-dimensional barcode based on the information regarding the structure of the one-dimensional barcode and the information regarding the resolution of the display device, the scaling factor at which a space width of the one-dimensional barcode is equal to an integral multiple of a width of a display pixel of a display device displaying the one-dimensional barcode, the one-dimensional barcode is within a display area of the display device, and a length of the one-dimensional barcode is equal to a read width of a barcode reader required for reading the one-dimensional barcode or more.

10. A non-transitory computer-readable medium having stored thereon an one-dimensional barcode resizing program for causing a computer to function as the one-dimensional barcode resizing device according to claim 1.

11. A one-dimensional barcode system comprising:
the one-dimensional barcode resizing device according to claim 8; and
a barcode reader reading a one-dimensional barcode displayed on the display device.
